(19) United States
(12) Patent Application Publication
(10) Pub. No.: US 2025/0140547 A1
(43) Pub. Date: May 1, 2025

(54) ELECTRIC LIGHT BULB REPLACEMENT DEVICE WITH A PROTECTION SHELL

(71) Applicant: George Huang, Natick, MA (US)

(72) Inventor: George Huang, Natick, MA (US)

(21) Appl. No.: 18/386,076

(22) Filed: Nov. 1, 2023

(51) Int. Cl. H01K 3/32; F21V 19/04

(52) U.S. Cl. CPC H01K 3/32; F21V 19/04

(57) ABSTRACT

The present invention provides an electric motor-powered light bulb replacement device with a protection shell, which has a unique design in power switch mechanism and a transparent round shape anti-debris protection shell around the device. Such electric light bulb replacement device comprises a light bulb screwing head connector, a fixed housing, a USB TYPE C charging socket, a forward and reverse switch, a protection shell, and a fixed base.

### FIELD OF THE INVENTION

The present invention relates to a light bulb replacement device, and in particular to an electric light bulb replacement device with a protection shell to prevent broken glass debris or dust from falling down.

### BACKGROUND OF THE INVENTION

Light bulbs are commonly used lighting equipment, usually a light bulb is screwed in its holder by thread in the ceiling of a room. Due to the higher position of the light bulb, it is very inconvenient to replace the light bulb by hand. Considering the uneven force of manual rotation is easy to cause unstable rotation and the people's hand is not strong enough and becomes fatigue after continuous work, plus people with finger and wrist injuries who have difficulty doing such jobs for a light bulb replacement, so it is necessary to invent an electric light bulb replacement device to uninstall and install the light bulb without manual rotation. The existing device with an extension rod on the light bulb screwing head is still high labor intensity and low efficiency. For example, Lowe's product model 887470 or similar products are currently on the market all need manual rotation. Additionally, changing dead or old light bulbs could be risky since the broken glass debris or dust caused during the screwing process will be falling down into people's eyes or head and other parts of the body. Thus, a safe, convenient, efficient and labor-saving light bulb replacement device is highly needed.

### BRIEF DESCRIPTION OF THE DRAWINGS

FIG. 1 is a perspective view of the present invention with a light bulb screwing head on the top and an extension rod at the bottom.

FIG. 2 is a top perspective view of the present invention.

FIG. 3 is a one side view of the present invention.

FIG. 4 is a different side view of the present invention.

FIG. 5 is another different side view of the present invention.

FIG. 6 is a top view of the present invention.

FIG. 7 is a bottom view of the present invention.

FIG. 8 is a bottom perspective view of the present invention.

FIG. 9 is a schematic diagram of the present invention.

FIG. 10 is a schematic diagram of the internal structure of the present invention.

FIG. 11 is a schematic diagram of the sliding snap connection of the present invention.

FIG. 12 is a schematic diagram of the switching trigger of the present invention.

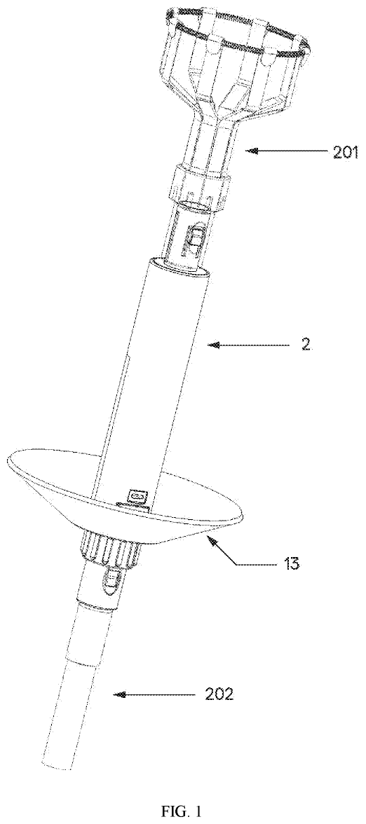

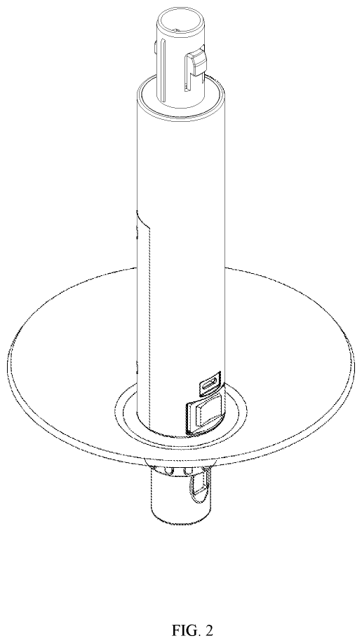

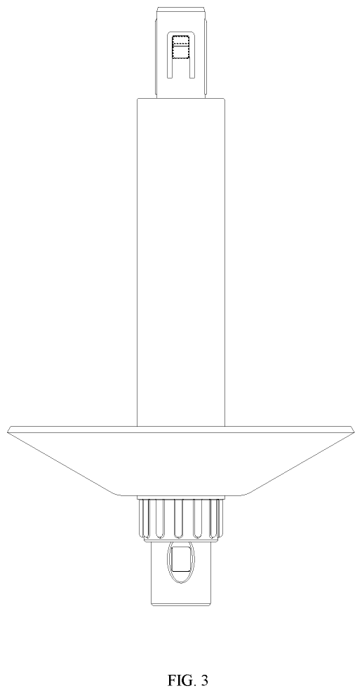

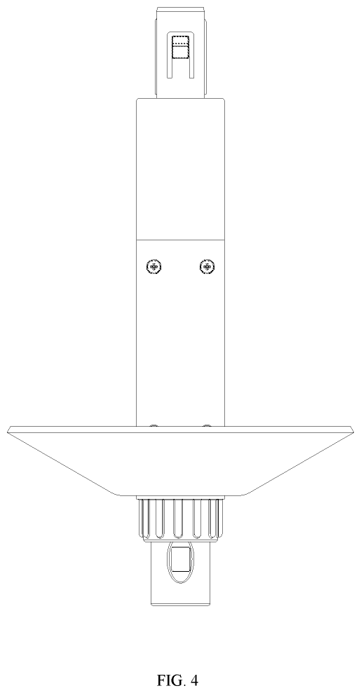

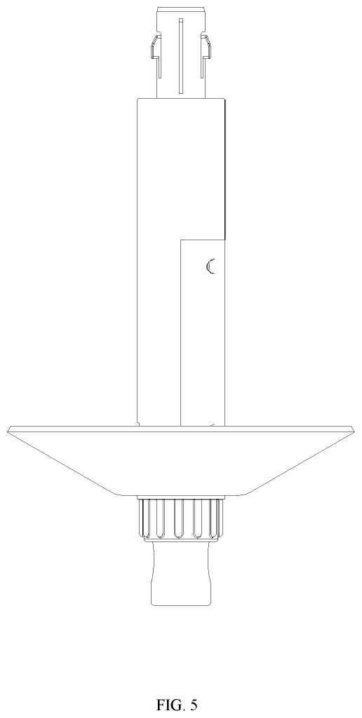

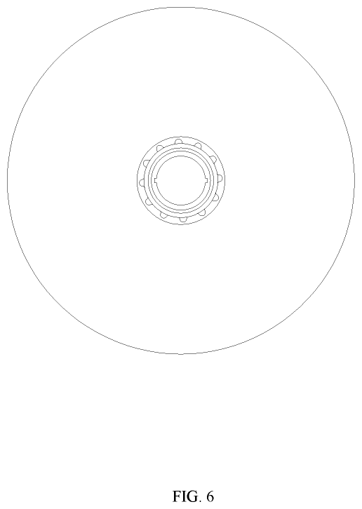

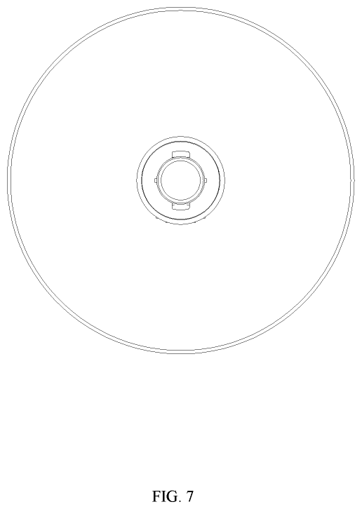

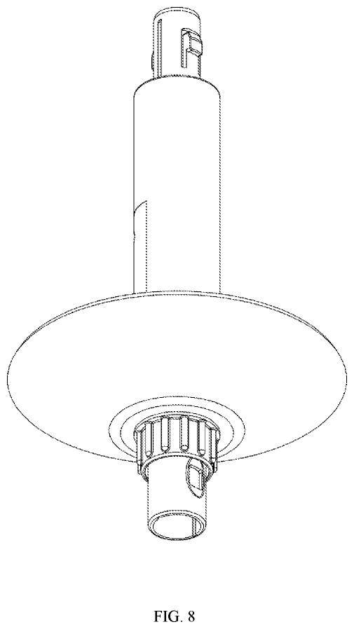

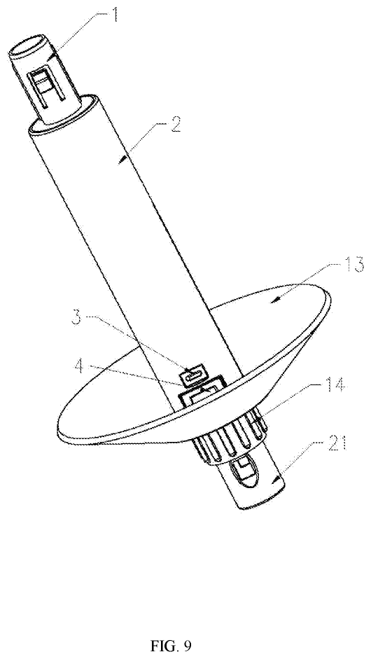

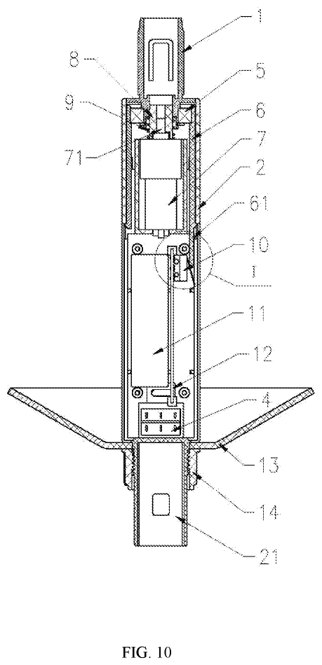

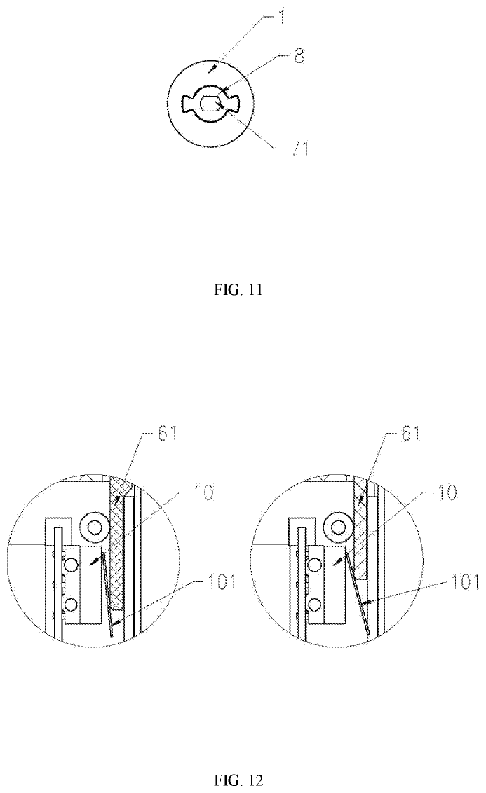

### DETAILED DESCRIPTION OF THE PREFERRED EMBODIMENTS

The technical solution adopted by the present invention is an electric light bulb screwing device with a protection shell, comprising a fixed housing (2), a light bulb screwing head connector (1), a forward and reverse switch (4), a USB TYPE C charging socket (3) and a fixed base (21) integrated with the fixed housing (2), wherein the lower end of the fixed housing (2) is located above the fixed base (21), and a protection shell (13) which is held by a nut (14) and around the fixed housing (2), wherein the nut (14) has anti-slip ribs on the outer round surface; The fixed housing (2) is equipped with motor (7), lithium battery (11), control board (12), forward and reverse switch (4); A output shaft (71) of the motor (7) is fixed with a drive head (8), the outer sleeve of the drive head (8) is set with the light bulb screwing head connector (1), the lower part of the light bulb screwing head connector (1) is axially installed with a recoverable spring (9), the lower periphery of the light bulb screwing head connector (1) is installed with a deep groove ball bearing (5), and the outer ring of the deep groove ball bearing (5) is fixed at one end of the sliding sleeve (6); The control board (12) is designed with a start switch (10) and a USB TYPE C charging socket (3).

In the above design, the fixed housing (2) is round and cylindrical shape, one end of which is installed with the light bulb screwing head connector (1), the function of the a light bulb screwing head connector (1) is to snap with the a light bulb screwing head (201) and twist the light bulb head connector (1) with the a light bulb screwing head (201), and the a light bulb screwing head connector (1) is retractable; The other end of the fixing housing (2) is designed with an integrated fixed base or holder (21), and the holder (21) is used to fix or connect the device to other tools like an extension rod (202). Forward and reverse toggle switch (4), USB TYPE C charging socket (3), located on the surface of the fixed housing (2).

In the above design, the output shaft (71) of the motor (7) is fixed with a drive head (8) by an interference fit; Between the drive head (8) and the outside sleeve of the light bulb screwing head connector (1), there is a sliding snap, which can help the drive head (8) and the a light bulb screwing head connector (1) slide axially relative to each other, but the circumferential direction is snapped and cannot move relative to each other; The lower part of the a light bulb screwing head connector (1) is axially installed with a recoverable spring (9), one end of the recoverable spring (9) is supported on the end face of the light bulb screwing head connector (1), and the other end is supported on the end face of the casing of the motor (7), when the fixed housing (2) is not moving and when the a light bulb screwing head connector (1) is under pressure, due to the axial sliding between the a light bulb screwing head connector (1) and the drive head (8), the recoverable spring (9) is compressed, then the a light bulb screwing head connector (1) is retracted to the fixed housing (2), which triggers the motor (7) starts and the drive head (8) fixed on the output shaft (71) of the motor (7) will drive the a light bulb screwing head connector (1) to rotate; when the pressure force acting on the a light bulb screwing head connector (1) disappears, the light bulb screwing head connector (1) can extend to the original position under the action of the recoverable spring (9), the sliding snap between the drive head (8) and the light bulb screwing head connector (1) also limits the circular direction movement between them, which will stop the motor (7) starts and the drive head (8) fixed on the output shaft (71) of the motor (7) will not drive the a light bulb screwing head connector (1) to rotate.

In the above design, a deep groove ball bearing (5) is installed on the lower periphery of the light bulb screwing head connector (1), the outer ring of the deep groove ball bearing (5) is fixed at one end of the sliding sleeve (6), and the other end of the sliding sleeve (6) is designed with barbs, which can be hooked on the housing of the fixed housing (2), one of the barbs has an extension (61), and the extended part is used as a pressure plate (61). The light bulb screwing head connector (1) through the deep groove ball bearing (5) and the sliding sleeve (6) to form a rotary connection, when the light bulb screwing head connector (1) is retracted or pressed down, the stuck sliding sleeve (6) moves in the same direction, as the pressure plate (61) integrated with the sliding sleeve also moves in the same direction, a swing rod (101) of a micro switch (10) designed next to the pressure plate (61) is pressed, the switch is turned on, under the control of the control board (12) and the forward and reverse switch (4), the motor (7) starts; when the a light bulb screwing head connector (1) extends back to its original position, The pressure plate (61) also loosens the swing rod (101), the switch is disconnected, and the motor (7) stops rotating; There is a deep groove ball bearing (5) between the light bulb screwing head connector (1) and the sliding sleeve (6), and when the motor (7) starts, driving the light bulb screwing head connector (1) to rotate, the sliding sleeve (6) will not rotate since the barbs hook at one end of the sliding sleeve (6) on the housing of the fixed housing (2), when the light bulb screwing head connector (1) extends outward under the action of the recoverable spring (9), due to the barb of the sliding sleeve (6) snapped together with the shell of the fixed housing (2), and the light bulb screwing head connector (1) will be blocked, and can only extend to the original position.

In the above design, the lower end of the fixed housing (2) is located above the fixed base (21), and the anti-debris protection shell (13) is held with the fixed housing (2) by a nut (14), the outer round surface of the nut (14) has anti-slip ribs, which can be removed or installed by manually screwing the nut (14) to remove or install the anti-debris protection shell (13).

In the above design, the battery (11), the control board (12), the forward and reverse switch (4) is installed in the fixed housing (2), the control board (12) is welded with a micro switch (10) and a USB TYPE C charging socket (3). The whole device is powered by the battery (11) under the joint control of the control board (12) and the forward and reverse switch (4). The battery (11) has a layer of protection around it. The forward and reverse switch (4) adopts a double-pole double-throw rocker switch, which has a simple structure and is low cost.

Except all the above designs, one of the novel designs in this invention is a round protection shell attached to and around the fixed housing (2) to prevent broken glass debris or dust from falling down. Such protection shell is made from transparent rubber material which allows people to see through it for light bulb replacement job. With such a protection shell, changing dead or old light bulbs will be much safer since it will block or receive all the broken glass debris or dust caused during the screwing process and prevent them from falling down into people's eyes or head and other parts of the body.

In summary, the present invention provides a novel device for light bulb replacement application. It is an electric motor-powered light bulb replacement device with a protection shell. Although this device and the method of using the same according to the present invention have been described in the foregoing specification with considerable details, it is to be understood that modifications may be made to the invention which do not exceed the scope of the claims and modified forms of the present invention done by others skilled in the art to which the invention pertains will be considered infringements of this invention when those modified forms fall within the claimed scope of this invention.

1. An electric light bulb replacement device with a protection shell, comprising a light bulb screwing head connector, a fixed housing, a USB TYPE C charging socket, a forward and reverse switch, a protection shell, and a fixed base.
Wherein said light bulb screwing head connector is integrated with the fixed housing, wherein the lower end of said fixed housing is located above said fixed base;
Wherein said protection shell is made by transparent material with a round shape around the fixed housing and is held by a nut, wherein the nut has anti-slip ribs on the outer round surface of the nut;
Wherein said fixed housing consists of a motor, a lithium battery, a control board, a forward and reverse switch, wherein a output shaft of the motor is fixed with a drive head, wherein the outer sleeve of the drive head is set with the light bulb screwing head connector, wherein the lower part of the light bulb screwing head connector is axially installed with a recoverable spring, wherein the lower periphery of the light bulb screwing head connector is installed with a deep groove ball bearing, wherein the outer ring of the deep groove ball bearing is fixed at one end of a sliding sleeve;
Wherein the fixed housing is round and cylindrical shape, one end of which is installed with the light bulb screwing head connector, the other end of the fixing housing is designed with the integrated fixed base which is used to fix or connect the device to an extension rod; wherein said forward and reverse switch and said USB TYPE C charging socket are located on the surface of the fixed housing; Wherein the battery, the control board, the forward and reverse switch are installed in the fixed housing, the control board is welded with a micro switch and a USB TYPE C charging socket;
Wherein the output shaft of the motor is fixed with the drive head by an interference fit, wherein there is a sliding snap between the drive head and the outside sleeve of the light bulb screwing head connector, which can help the drive head and the light bulb screwing head connector slide axially relative to each other but cannot move in a circumferential direction relative to each other;
Wherein the lower part of the light bulb screwing head connector is axially installed with a recoverable spring, one end of the recoverable spring is supported on the end of the light bulb screwing head connector, and the other end is supported on the end of the casing of the motor;
Wherein a deep groove ball bearing is installed on the lower periphery of the light bulb screwing head connector, the outer ring of the deep groove ball bearing is fixed at one end of the sliding sleeve, and the other end of the sliding sleeve is designed with barbs, which can be hooked on the housing of the fixed housing, one of the barbs has an extension, and the extended part of the barb is used as a pressure plate;
Wherein the light bulb screwing head connector form a rotary connection with the sliding sleeve through the deep groove ball bearing, when the light bulb screwing head connector is retracted or pressed down, the sliding sleeve moves in the same direction, as the pressure plate integrated with the sliding sleeve also moves in the same direction, wherein a swing rod of a micro switch is designed next to the pressure plate is pressed, the switch is turned on under the control of the control board, then the motor starts rotating; when the a light bulb screwing head connector extends back to its original position, the pressure plate will loosen the swing rod, the switch is disconnected, then the motor stops rotating;
Wherein there is a deep groove ball bearing between the light bulb screwing head connector and the sliding sleeve, when the motor starts, driving the light bulb screwing head connector to rotate and the sliding sleeve will not rotate since the barbs hook at one end of the sliding sleeve on the housing of the fixed housing; when the light bulb screwing head connector extends outward under the action of the recoverable spring, due to the barb of the sliding sleeve snapped together with the shell of the fixed housing, the light bulb screwing head connector will be blocked and can only extend to the original position;
Wherein the forward and reverse switch is a double-pole double-throw rocker switch.
